(19) United States
(12) Patent Application Publication
(10) Pub. No.: US 2019/0084459 A1
(43) Pub. Date: Mar. 21, 2019

(54) COVERING DEVICE FOR A THROUGH-LOADING OPENING OF A VEHICLE INTERIOR

(71) Applicants: Jan BODDENBERG, Köln (DE); Hartmut BOHLKE, Wuppertal (DE); Andreas GÖBBELS, Kürten (DE); Tanja PINK, Wuppertal (DE); Wolfgang SITZLER, Wuppertal (DE); Bogdan TUTELEA, Leichlingen (DE)

(72) Inventors: Jan BODDENBERG, Köln (DE); Hartmut BOHLKE, Wuppertal (DE); Andreas GÖBBELS, Kürten (DE); Tanja PINK, Wuppertal (DE); Wolfgang SITZLER, Wuppertal (DE); Bogdan TUTELEA, Leichlingen (DE)

(21) Appl. No.: 16/124,383

(22) Filed: Sep. 7, 2018

(30) Foreign Application Priority Data
Sep. 19, 2017 (DE) 10 2017 216 555.3

(51) Int. Cl. B60N 2/75

(52) U.S. Cl. CPC B60N 2/757; B60N 2205/35; B60N 2/767

(57) ABSTRACT

Covering device for a through-loading opening of a vehicle interior having first and second housing shells joined together to form a substantially rectangular covering cassette, and a reinforcing arrangement formed from two reinforcing elements and arranged between the housing shells. The reinforcing arrangement reinforces the covering cassette and is provided for a pivotable vehicle-mounted connection of the covering cassette to a rear seatback arrangement surrounding the through-loading opening and additionally for the pivotable support of a central rest arrangement. In a fixedly-mounted state of the covering device, the covering cassette is pivotable relative to the rear seatback arrangement between a covering position and a release position. Each reinforcing element is formed as a longitudinal profile, which profiles are joined with the covering cassette while each extending substantially in the longitudinal direction of the covering cassette and being separated from one another.

### CROSS-REFERENCE TO RELATED APPLICATIONS

This claims priority from German Patent Application No. 10 2017 216 555.3, filed on Sep. 19, 2017, the disclosure of which is hereby incorporated by reference in its entirety.

### TECHNICAL FIELD

The invention relates to a covering device for a through-loading opening of a vehicle interior having at least a first housing shell and a second housing shell which are each produced from plastic and joined together to form a substantially rectangular covering cassette, and having a reinforcing arrangement which is produced from metal and formed from at least two reinforcing elements and arranged in an interspace formed between the housing shells, by means of which reinforcing arrangement the covering cassette is reinforced and which is provided for a pivotable vehicle-mounted connection of the covering cassette to a rear seatback arrangement surrounding the through-loading opening and additionally for the pivotable support of a central rest arrangement, wherein, in a state of the covering device in which it is mounted fixedly with respect to the vehicle, the covering cassette is pivotable relative to the rear seatback arrangement between a covering position, in which the covering cassette closes the through-loading opening, and a release position, in which the covering cassette releases the through-loading opening.

### BACKGROUND

Such a covering device is generally known in the field of vehicle technology. The known covering device is provided for selectively closing and releasing a through-loading opening of a passenger car that extends through a rear seatback arrangement, and has a substantially rectangular covering cassette. The covering cassette is formed from two housing shells which are produced from plastic and joined together to form an interspace. The covering cassette is reinforced by means of a reinforcing arrangement which is formed from a plurality of reinforcing elements. The reinforcing arrangement is arranged in the interspace formed between the housing shells and produced from metal and provided, on the one hand, for the pivotable vehicle-mounted connection of the covering cassette to the rear seatback arrangement. On the other hand, the reinforcing arrangement serves for the pivotable support of a central rest arrangement on the covering device. In a state of the covering device in which it is mounted fixedly with respect to the vehicle, the covering cassette is pivotable between a covering position and a release position. In the covering position, the covering cassette closes the through-loading opening. In the release position, the covering cassette releases the through-loading opening. Starting from the covering position, and in a state of the central rest arrangement in which it is mounted as intended on the covering device, said central rest arrangement is, in a manner known in principle, pivotable relative to the covering device—and thus relative to the rear seatback arrangement—between a folded-down functional position, in which the central rest arrangement is provided as an armrest, and a folded-in use position, in which the central rest arrangement is provided as a backrest. In the case of the known covering device, the reinforcing elements of the reinforcing arrangement are welded to one another in the form of a welded structure. Here, the reinforcing elements are each of plate-shaped design and arranged in such a way that the reinforcing arrangement is subdivided in the longitudinal direction of the covering cassette by a plurality of welded connections.

### SUMMARY

It is an object of the invention to provide a covering device of the type stated at the outset that has improved properties and allows more cost-effective manufacture in particular combined with improved mechanical properties.

This object is achieved in that the reinforcing elements are produced in the form of in each case a longitudinal profile, which profiles are joined together with the covering cassette while each extending in one piece substantially in the longitudinal direction of the covering cassette and being separated from one another. The solution according to the invention achieves an improved design strength of the reinforcing arrangement. Since here the longitudinal profiles extend in one piece in the longitudinal direction and in this respect are not subdivided by welded connections and/or other joining connections, it is possible, when the covering device is loaded as intended, to achieve an improved force flow and hence—with a material outlay which is equal or reduced in relation to known covering devices—reduced stressing and thus improved stiffness. In addition, there is no need to join together, in particular weld, the connecting elements by virtue of the solution according to the invention. Instead, the reinforcing elements are each joined together with the covering cassette so as to be separated from one another, i.e. separately in each case, with the result that there is no direct mechanical connection between the reinforcing elements. Consequently, it is possible to have an improved stiffness of the covering device while saving on manufacturing outlay at the same time. The longitudinal profiles are produced from metal, for example from steel or aluminum, and can have an open or a closed profile cross section. In particular, to achieve a design of the reinforcing arrangement that is as flat as possible, it is advantageous if the longitudinal profiles each have an open profile cross section, for example a substantially L-, I-, U-, W- or C-shaped profile cross section. The longitudinal profiles can each be joined to the covering cassette in a force- and/or form-fitting manner, for example in each case by means of a screw connection, a riveted connection, a latching connection or an adhesive connection. The longitudinal profiles are preferably joined to one and the same housing shell of the covering cassette. The terms longitudinal, transverse and vertical direction used in this description refer to a coordinate system of the covering device in a state in which it is mounted fixedly with respect to the vehicle in the vehicle interior as intended, with the coordinate system of the covering device corresponding to a coordinate system of the associated vehicle, namely a vehicle longitudinal direction, a vehicle transverse direction and a vehicle vertical direction. In this respect, the longitudinal direction of the covering cassette is oriented substantially parallel to the vertical direction in the covering position and substantially parallel to the longitudinal direction in the release position.

In an embodiment of the invention, precisely two longitudinal profiles are provided which extend spaced apart parallel to one another, preferably substantially over an entire length of the covering cassette. The longitudinal profiles are preferably each configured to be narrow by comparison with a width of the covering cassette. A design which is particularly suitable in terms of stressing can be achieved if the longitudinal profiles are arranged substantially symmetrically to an imaginary center longitudinal plane of the covering cassette.

In a further embodiment of the invention, the longitudinal profiles each have a connecting portion which is provided for the pivotable vehicle-mounted connection of the covering cassette to the rear seatback arrangement and has a bolt receptacle and/or a pivot pin receptacle. The connecting portions are preferably arranged—with respect to the covering position—in a lower end-side region of the respective longitudinal profile. Bolt receptacles can each be provided for the releasable connection of the reinforcing arrangement, and thus of the covering device, on a connecting means assigned to the rear seatback arrangement. The pivot pin receptacles of the longitudinal profiles are arranged coaxially and provided for connection to a pivot pin, which is fixed on the rear seatback arrangement, or in each case to a pivot bolt. In a state of the covering device in which it is mounted fixedly with respect to the vehicle, the covering cassette is connected to the rear seatback arrangement by means of the connecting portions so as to be pivotable about an axis which is preferably oriented parallel to the transverse direction.

In a further embodiment of the invention, the longitudinal profiles each have a supporting portion which projects from the interspace of the covering cassette and which is provided for the pivotable support of the central rest arrangement on the covering device and has a bearing pin receptacle. The supporting portions are each preferably arranged—with respect to the covering position—above the connecting portion of the longitudinal profile if the longitudinal profile has such a connecting portion. In this respect, the supporting portions are each substantially arranged centrally—with respect to an overall length of the respective longitudinal profile. The supporting portions can each be designed in the form of an extension which is arranged on a profile wall portion of the respective longitudinal profile that is situated externally with respect to the transverse direction. These extensions are preferably each bow-shaped and in this respect have a rounded-off outer contour to avoid stress peaks. The bearing pin receptacles of the longitudinal profiles are oriented coaxially to one another and provided for receiving a bearing pin, which is assigned to the central rest arrangement, or in each case a bearing bolt or the like. In a state of the central rest arrangement in which it is mounted as intended on the covering device, said central rest arrangement is supported pivotably on the supporting portions and is pivotable between—starting from the covering position of the covering cassette—a folded-down functional position, in which the central rest arrangement is provided as an armrest, and a folded-in use position, in which the central rest arrangement is provided as a backrest, relative to the covering device.

In a further embodiment of the invention, the longitudinal profiles are designed and/or arranged to be substantially mirror-symmetrical to one another. The longitudinal profiles are preferably arranged mirror-symmetrically to an imaginary center longitudinal plane of the covering device, in particular of the covering cassette. Insofar as a central rest arrangement connected to the covering device assumes a folded-down functional position, the latter is usually loaded approximately centrally with respect to the transverse direction, for example by the bearing of an arm. Consequently, a mirror-symmetrical arrangement of the longitudinal profiles makes it possible to achieve a stressing of the reinforcing arrangement that is symmetrical under the above-described loading, and thus distortion of the reinforcing arrangement can be avoided.

In a further embodiment of the invention, the longitudinal profiles are each produced in the form of a cut and bent sheet metal component which is cut from sheet metal and has a plurality of wall portions which are bent off with respect to one another. In this respect, the longitudinal profiles each have at least one elongate bent-off portion. If the respective longitudinal profile has for example precisely one elongate bent-off portion, the longitudinal profile can have an L-shaped profile cross section. The longitudinal profiles preferably each have a plurality of elongate bent-off portions, with the result that the respective profile cross sections have for example a U- or W-shaped basic shape. It is possible in this way for an improved stiffness of the longitudinal profiles to be achieved with simple means. The longitudinal profiles are each preferably produced from a semifinished sheet metal product which is configured to be thin-walled by comparison with a thickness dimension of the covering cassette. If the housing shells of the covering cassette are each of thin-wall design, which is preferably the case, the wall thickness of the longitudinal profiles substantially corresponds to the wall thickness of the housing shells. This is an embodiment of the invention that can be produced in a particularly cost-effective and simple manner.

In a further embodiment of the invention, the longitudinal profiles are each nonreleasably connected to an inner wall portion of the covering cassette in a force- and/or form-fitting manner by means of fastening elements. The fastening elements can each be designed in the form of a screw, a rivet, a latching element or the like. The longitudinal profiles preferably each have fastening openings which are in operative connection with in each case one of the fastening elements.

In a further embodiment of the invention, the fastening elements are designed in each case in the form of a welding dome which is produced from plastic and which is connected in an integrally bonded manner to the inner wall portion of the covering cassette. Such welding domes are known in principle and are referred to for example as thermal integral bonding domes. In the case of the associated joining process, which is likewise known in principle, a substantially cylindrical fastening element produced from thermoplastic is applied under a defined rotational speed and axial load to a carrier component and in this way connected thereto in an integrally bonded manner, similar to a conventional friction welding operation. For this purpose, it is necessary that the carrier component is produced from a plastic which can be connected in an integrally bonded manner under the action of heat to the plastic of such a fastening element. In this way, an integrally bonded connection is produced between the carrier component, here the inner wall of the covering cassette, and the welding dome. By contrast, a force- and/or form-fitting connection is produced between the welding dome and the longitudinal profile, for example by means of a mushroom head-shaped dome which is formed on the end side of the welding dome and whose outside diameter exceeds an outside diameter of a fastening opening in the respective longitudinal profile. This is a particularly weight-optimized embodiment of the invention.

In a further embodiment of the invention, an inner wall portion of the covering cassette that is arranged in the transverse direction between the longitudinal profiles is provided with a ribbing which has a plurality of ribs which are oriented transversely to one another, preferably at a right angle. An additional reinforcement of the covering cassette can be achieved in such a way. The ribbing can be designed in the form of components produced separately from the housing shells of the covering cassette. Alternatively, the ribbing can be formed in one piece on the inner wall portion of the covering cassette.

### BRIEF DESCRIPTION OF THE DRAWINGS

Further advantages and features of the invention will emerge from the claims and from the following description of preferred exemplary embodiments of the invention which are illustrated with reference to the drawings.

FIG. 1 shows a schematic perspective illustration of an interior of a passenger car in the region of a rear seatback arrangement with a through-loading opening which is provided with one embodiment of a covering device according to the invention,

FIG. 2 shows the covering device according to FIG. 1 in a schematic, perspective exploded illustration,

FIG. 3 shows the covering device according to FIGS. 1 and 2 with a retaining bracket (FIG. 4) assigned to the rear seatback arrangement according to FIG. 1 in a schematic perspective illustration,

FIG. 4 shows the retaining bracket assigned to the rear seatback arrangement in a schematic, perspective detail illustration,

FIG. 5 shows the covering device according to FIGS. 1 to 3 in a further schematic perspective illustration, with the omission of one housing shell,

FIGS. 6a, 6b show the covering device according to FIGS. 1 to 3 and 5 in a schematic plan view (FIG. 6a) and a longitudinal sectional illustration (FIG. 6b), with the omission of one housing shell, and

FIGS. 7a, 7b show a further embodiment of a covering device according to the invention in illustrations corresponding to FIGS. 6a and 6b.

### DETAILED DESCRIPTION

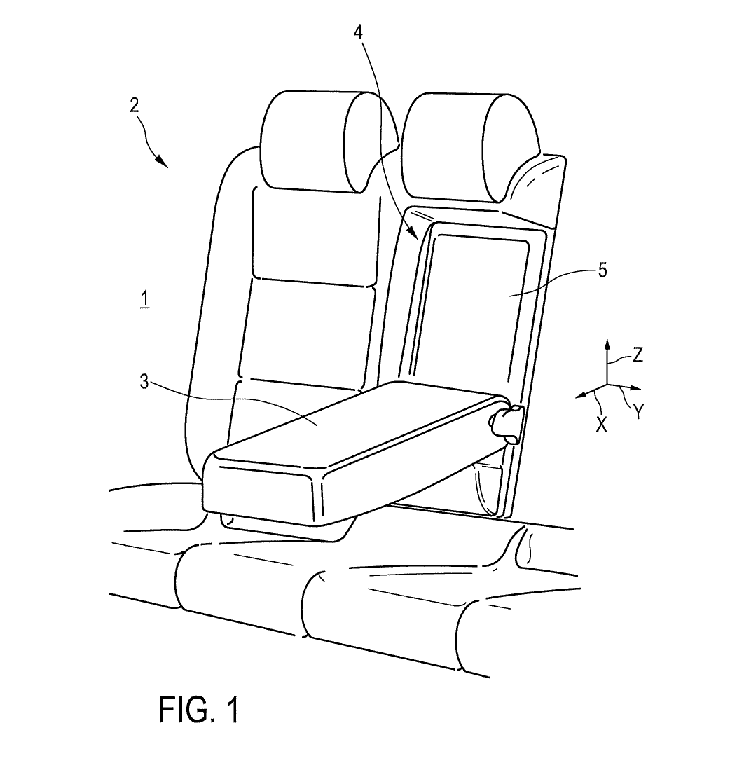

According to FIG. 1, a vehicle interior 1 of a passenger car, which is not visible in further detail, is provided with a rear seatback arrangement 2. The rear seatback arrangement 2 is arranged in a rear region of the vehicle interior 1 and has a central rest arrangement 3. The central rest arrangement 3 is pivotable in a manner known in principle between a folded-down functional position, as is visible from FIG. 1 and in which the central rest arrangement 3 is provided as an armrest, and a folded-in use position, in which the central rest arrangement 3 is provided as a backrest. In the functional position, the central rest arrangement 3 is oriented substantially parallel to a vehicle longitudinal direction X. In the folded-in use position, the central rest arrangement 3 is oriented substantially vertically and in this respect parallel to a vehicle vertical direction Z. In the functional position, the central rest arrangement 3 releases a region of a through-loading opening 4. The through-loading opening 4 extends through the rear seatback arrangement 2 between a loading space, which is arranged behind the rear seatback arrangement 2 with respect to the vehicle longitudinal direction X and which is not visible in further detail, and the rear region. The through-loading opening 4 is provided for loading through elongate items to be transported such that they can be deposited in their longitudinal extent between the loading space and the rear region of the vehicle interior 1. In the configuration visible with reference to FIG. 1, the through-loading opening is closed by means of a covering device 5.

In a manner which will be described in more detail, the covering device 5 is pivotable relative to the rear seatback arrangement 2 between a covering position, as is visible with reference to FIG. 1 and in which the covering device 5 closes the through-loading opening 4, and a release position, in which the covering device 5 releases the through-loading opening 4. In addition—and in a manner which will likewise be described in further detail—the central rest arrangement 3 is supported on the covering device 5 so as to be pivotable relative to the covering device 5 and thus relative to the rear seatback arrangement 2.

In order to release the through-loading opening 4 starting from the configuration visible with reference to FIG. 1, the central rest arrangement 3 is first of all pivoted upward from the functional position about a pivot axis extending substantially parallel to a vehicle transverse direction Y and in this way transferred into the use position. In a subsequent step, the covering device 5 is unlocked from the rear seatback arrangement 2 in a manner known in principle and is pivoted forward about an axis, which extends substantially parallel to the vehicle transverse direction Y and is arranged in a lower end region of the covering device 5, until an approximately horizontal orientation is reached and the through-loading opening 4 is substantially completely released.

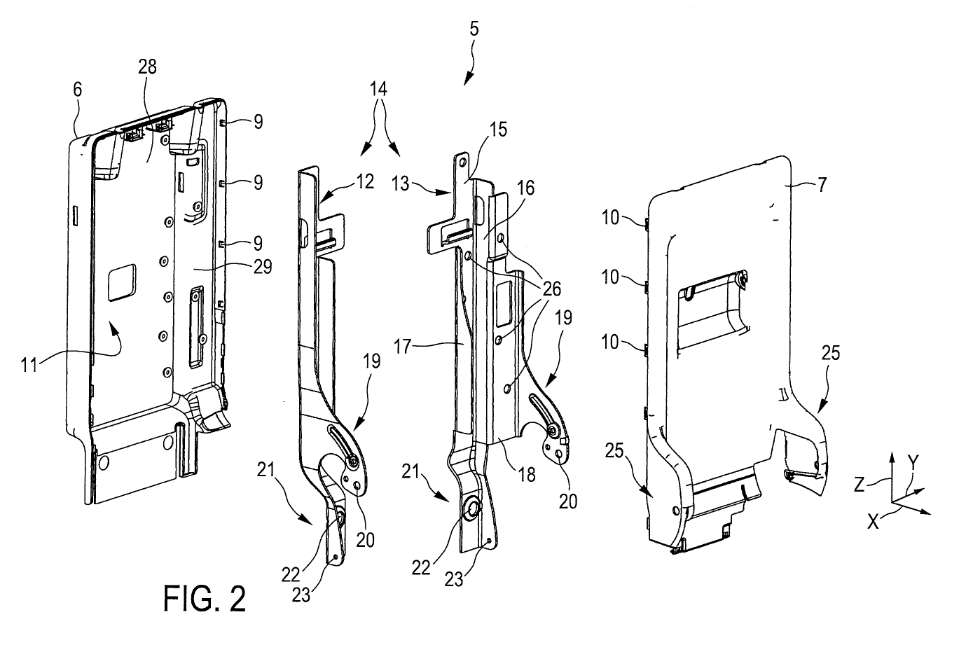

Details of the structural and functional design of the covering device 5 are visible with reference to FIGS. 2, 3 and 5 to 6b.

The covering device 5 has a first housing shell 6 and a second housing shell 7 which are each produced from plastic and joined together to form a substantially rectangular covering cassette 8. In the present case, the housing shells 6, 7 are each produced as plastic injection-molded components and configured to be substantially thin-walled. The housing shells 6, 7 are connected to one another in a force- and/or form-fitting manner by means of latching elements 9, 10 which are designed to be complementary with one another, and thus form the covering cassette 8. Alternatively, or in addition, the housing shells 6, 7 can be connected to one another in an integrally bonded manner by means of a plastic welding process which is known in principle.

A reinforcing arrangement 14 which is produced from metal and has two reinforcing elements 12, 13 is provided in an interspace 11 formed between the housing shells 6, 7. The reinforcing arrangement 14 is connected to the covering cassette and provided for mechanical reinforcement thereof in a manner which will be described in further detail. In addition, the reinforcing arrangement 14 is provided, on the one hand, for the pivotable vehicle-mounted connection of the covering cassette 8 to the rear seatback arrangement 2 surrounding the through-loading opening 4 and, on the other hand, for the pivotable support of the central rest arrangement 3 on the covering device 5.

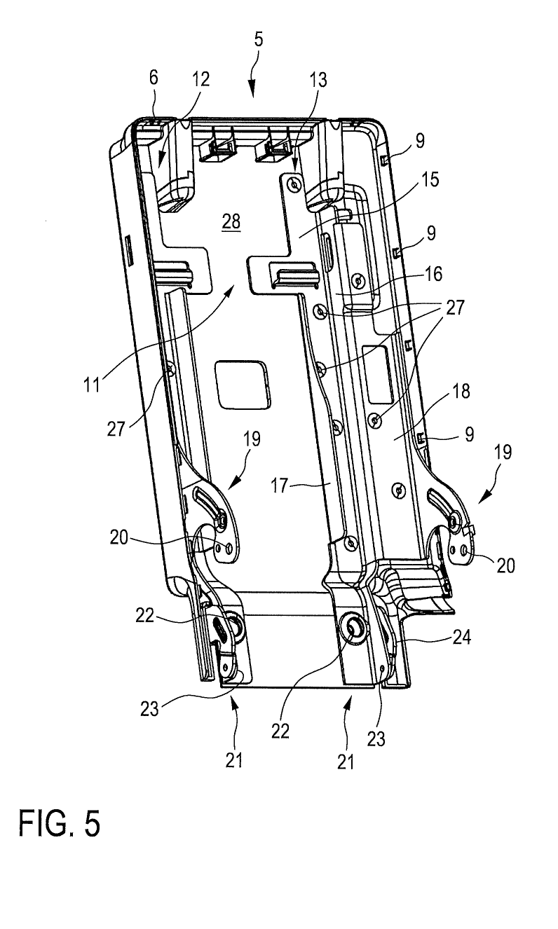

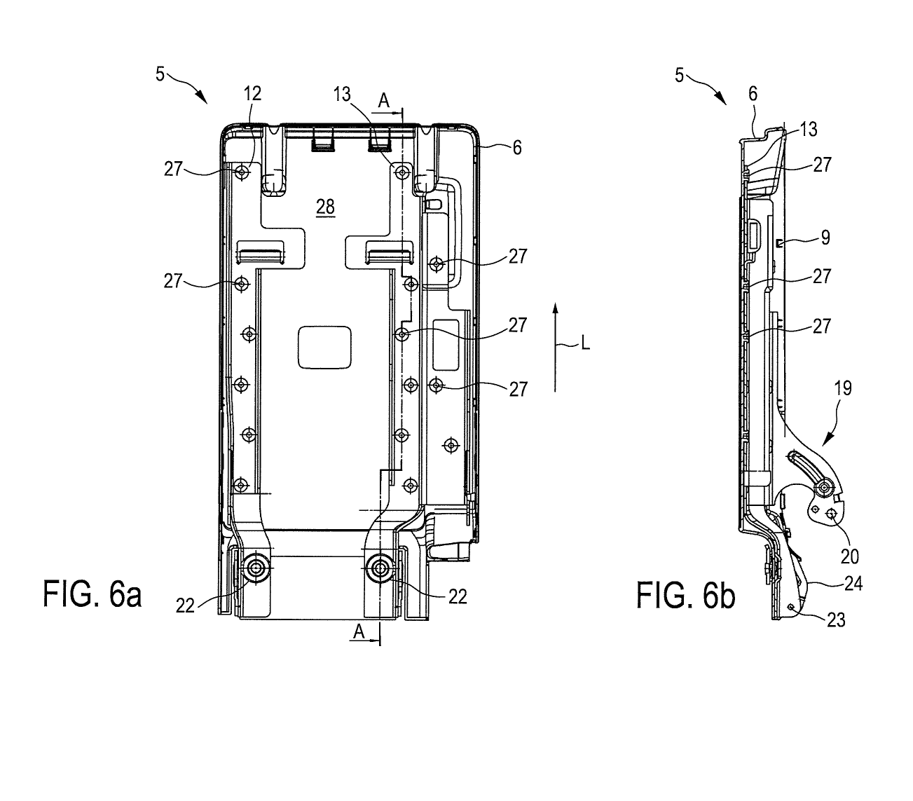

The reinforcing elements 12, 13 are each produced in the form of a longitudinal profile. As is visible in particular with reference to FIGS. 5 to 6b, the longitudinal profiles 12, 13 are joined together with the covering cassette 8 so as to extend substantially in the longitudinal direction L of the covering cassette 8 and to be separated from one another. More precisely, the longitudinal profiles 12, 13 are each joined together with the housing shell 6 of the covering cassette 8. The longitudinal profiles 12, 13 are each produced in one piece. There is no direct joining connection, in particular no welded connection, between the longitudinal profiles 12, 13. Instead, the longitudinal profiles 12, 13 are spaced apart from one another and each joined separately to the housing shell 6. The longitudinal profiles 12, 13 each extend substantially over the entire length of the covering cassette 8 and are arranged substantially mirror-symmetrically to an imaginary center longitudinal plane of the housing shell 6.

Furthermore, the longitudinal profiles 12, 13 are each produced in the form of a cut and bent sheet metal component and in this respect are cut from sheet metal and multiply bent off. The longitudinal profiles 12, 13 substantially correspond in their basic structural design, and therefore, to avoid repetitions, the discussion below will focus primarily on the configuration of the longitudinal profile 13. Here, reference will be made in particular to the coordinate system visible from FIGS. 1 and 2 and to an orientation of the longitudinal profile 13 in the covering position of the covering device.

The longitudinal profile 13 has a first vertically and transversely extending wall portion 15. The wall portion 15 extends in the vertical direction Z substantially over the entire length of the housing shell 6. In the transverse direction Y, the wall portion 15 is designed to be narrow by comparison with the housing shell 6. A second wall portion 16 and a third wall portion 17 are each provided in the transverse direction Y laterally with respect to the first wall portion 15. The wall portions 16, 17 are bent off forward through approximately 90° with respect to the longitudinal direction X relative to the first wall portion 15. In this respect, the wall portions 15, 16, 17 at least partially form a U-shaped profile cross section. With respect to the vertical direction Z, the wall portions 16, 17 are each designed to be shorter than the first wall portion 15. The third wall portion 17 has a setback in its upper region, with the result that the web height of the wall portion 17 is partially variable in the vertical direction Z. Laterally with respect to the second wall portion 16 there is provided a fourth wall portion 18 which extends parallel to the first wall portion 15. Laterally adjoining the fourth wall portion 18 there is provided a further wall portion which is oriented substantially parallel to the wall portions 16, 17 and designed in the form of a supporting portion 19. The supporting portion 19 is bow-shaped and provided for the pivotable support of the central rest arrangement 3 on the covering device 5. For this purpose, the supporting portion 19 has a bearing pin receptacle 20. The bearing pin receptacle 20 is provided for receiving a pivot pin, which is assigned to the central rest arrangement 3, or a pivot bolt. Furthermore, a connecting portion 21 is provided in a lower end region of the longitudinal profile 13. The connecting portion 21 is arranged both on the first wall portion 15 and on the second wall portion 16 and comprises a bolt receptacle 22 and a pivot pin receptacle 23. The connecting portion 21 is provided for the pivotable vehicle-mounted connection of the covering cassette 8 on the rear seatback arrangement 2. In a state in which the covering cassette is connected as intended to the rear seatback arrangement 2, the reinforcing arrangement 14 is connected to a retaining bracket 24 (FIG. 4) assigned to the rear seatback arrangement 2. For this purpose, the bolt receptacles 22 of the longitudinal profiles 12, 13 are each screwed, riveted or suchlike connected to the retaining bracket 24. The pivot pin receptacle 23 is provided for receiving a pivot pin (not visible in further detail) fixed pivotably to the rear seatback arrangement 2.

The configuration of the longitudinal profile 12 differs essentially from that of the longitudinal profile 13 in that no fourth wall portion 18 is provided. Instead, the longitudinal profile 12 is configured to be predominantly mirror-symmetrical in a corresponding manner to the longitudinal profile 13 and in this respect has in particular a supporting portion 19 with a bearing receptacle 20 and a connecting portion with a bolt receptacle 22 and a pivot pin receptacle 23.

The bearing pin receptacles 20 of the longitudinal profiles 12, 13 are oriented coaxially. During a displacement of the central rest arrangement 3 between the functional and use position, the central rest arrangement 3 is pivoted about an imaginary pivot axis extending between the bearing pivot receptacles 20. Accordingly, the pivot pin receptacles 23 of the longitudinal profiles 12, 13 are also oriented coaxially. During a displacement of the covering cassette 8 or of the covering device 5 between the covering and the release position, the covering cassette 8 is pivoted together with the reinforcing arrangement 14 about an imaginary axis extending between the pivot pin receptacles 23.

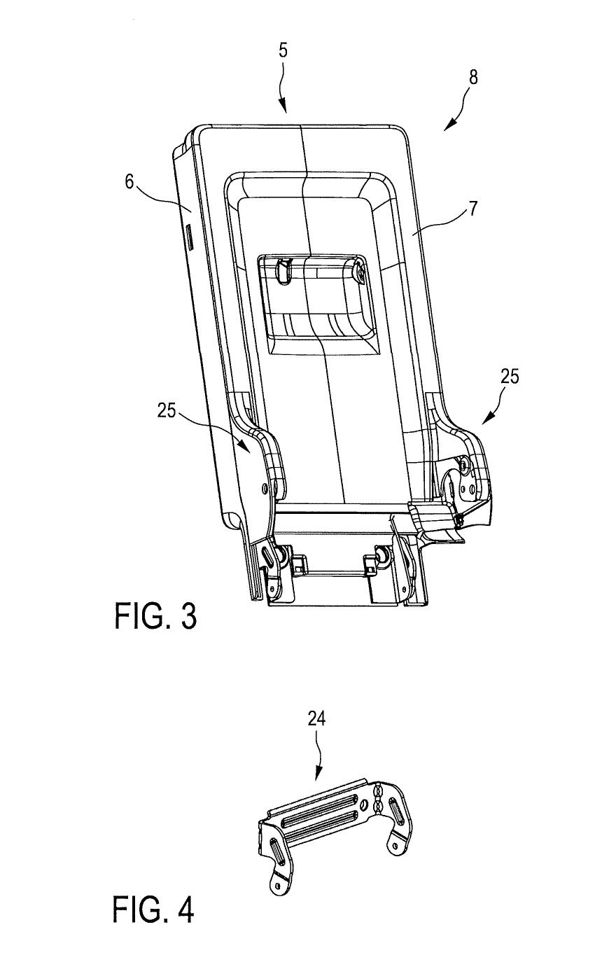

As is visible in particular with reference to FIG. 3, the supporting portions 19 each project from the interspace 11 formed between the housing shells 6, 7. In this way, the supporting portions 19 and in particular the bearing pin receptacles 20 for connecting the central rest arrangement 3 to the covering device 5 are freely accessible. Here, the supporting portions 19 are each covered laterally in the transverse direction by means of a side cheek 25 formed on the second housing shell 7.

To fasten the longitudinal profiles 12, 13 to the first housing shell 6 of the covering cassette 8, they each have a plurality of fastening openings 26. In the case of the longitudinal profile 13, the fastening openings 26 are arranged both in the first wall portion 15 and in the third wall portion 18. The fastening openings 26 are each produced in the form of a circular cylindrical bore.

As is visible in particular with reference to FIGS. 5 to 6b, the longitudinal profiles 12, 13 are each nonreleasably connected to the covering cassette 8 in a force- and/or form-fitting manner by means of fastening elements 27. More precisely, the longitudinal profiles 12, 13 are each connected to an inner wall portion 28 of the first housing shell 6. It is visible in particular with reference to FIG. 6b that the fastening elements are each designed in the form of a welding dome 27 which is produced from plastic and connected in an integrally bonded manner to the first housing shell 6. Some of the welding domes 27 are arranged on the inner wall portion 28 of the housing shell 6. Further welding domes 27 are arranged on an inner wall portion 29 (FIG. 2) which is offset in the longitudinal direction with respect to the inner wall portion 28. The welding domes 27 serve to produce a force- and/or form-fitting connection between the reinforcing arrangement 14 and the covering cassette. Here, the longitudinal profiles 12, 13 can be joined together with the housing shell 6 in particular in such a way that the longitudinal profiles 12, 13 are first arranged at the intended position of the inner wall 28, 29 of the housing shell 6. The welding domes 27 are subsequently inserted into the fastening openings 26 in a manner known in principle. Here, the welding domes 27 produced from plastic are pressed rotationally onto the housing shell 6 under an axial load. Consequently, the plastic materials of the housing shell 6 and of the welding domes 27 melt locally and undergo an integrally bonded connection.

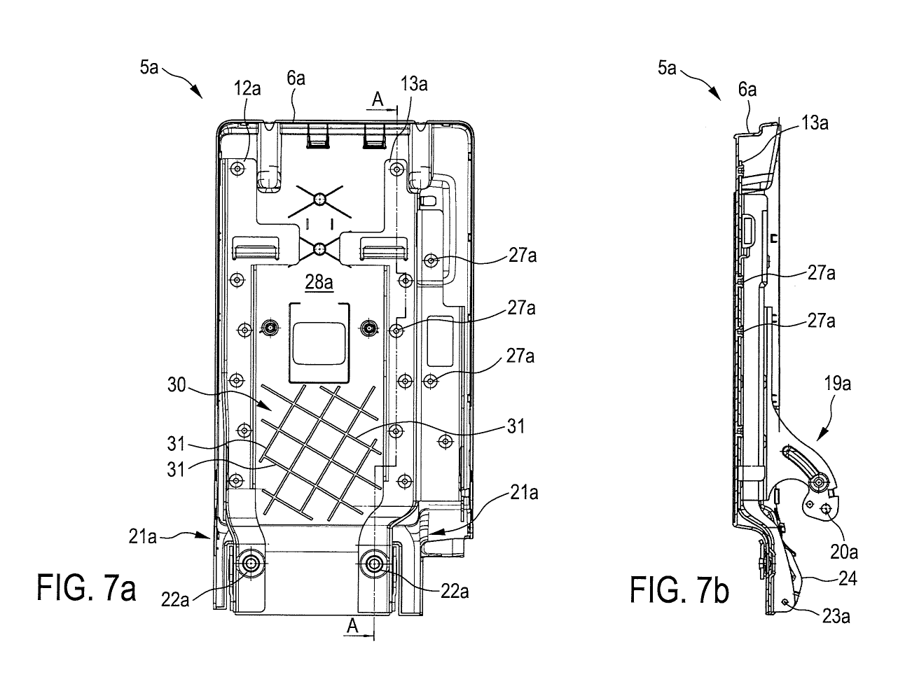

A further embodiment of a covering device 5a according to the invention is visible with reference to FIGS. 7a and 7b. Here, the embodiment according to FIGS. 7a and 7b essentially corresponds to the embodiment described above with reference to FIGS. 1 to 3 and 5 to 6b. In order to avoid repetitions, reference is therefore made to the disclosure of the embodiment according to the last-mentioned figures. Only the key differences will be discussed below. Functionally and/or structurally identical portions and parts of the embodiment according to FIGS. 7a, 7b are provided with the same reference signs with the addition of the lower-case letter a. The covering device 5a differs from the covering device 5 essentially in that an inner wall portion 28a of the covering cassette, more precisely of the first housing shell 6a, that is arranged in the transverse direction between the longitudinal profiles 12a, 13a is provided with a ribbing 30. The ribbing 30 has a plurality of ribs 31 oriented transversely to one another. The ribs 31 are connected in one piece to the housing shell 6a, for example by means of plastic injection-molding. Furthermore, the ribs 31 form a regular ribbing pattern with a square basic structure. This is inclined by approximately 45° with respect to a longitudinal direction of the housing shell 6a. Additional reinforcement is achieved by means of the ribbing 30.

1. Covering device for a through-loading opening of a vehicle interior having at least a first housing shell and a second housing shell which are each produced from plastic and joined together to form a substantially rectangular covering cassette, and having a reinforcing arrangement which is produced from metal and formed from at least two reinforcing elements and arranged in an interspace formed between the housing shells, by means of which reinforcing arrangement the covering cassette is reinforced and which is provided for the pivotable vehicle-mounted connection of the covering cassette to a rear seatback arrangement surrounding the through-loading opening and additionally for the pivotable support of a central rest arrangement, wherein, in a state of the covering device in which it is mounted fixedly with respect to the vehicle, the covering cassette is pivotable relative to the rear seatback arrangement between a covering position, in which the covering cassette closes the through-loading opening, and a release position, in which the covering cassette releases the through-loading opening, wherein the reinforcing elements are each produced in the form of a longitudinal profile, which profiles are joined together with the covering cassette while each extending in one piece substantially in the longitudinal direction of the covering cassette and being separated from one another.

2. Covering device according to claim 1, wherein precisely two longitudinal profiles are provided which extend spaced apart parallel to one another, preferably substantially over the entire length of the covering cassette.

3. Covering device according to claim 1, wherein the longitudinal profiles each have a connecting portion which is provided for pivotable vehicle-mounted connection of the covering cassette to the rear seatback arrangement and has a bolt receptacle and/or a pivot pin receptacle.

4. Covering device according to claim 1, wherein the longitudinal profiles each have a supporting portion which projects from the interspace of the covering cassette and which is provided for the pivotable support of the central rest arrangement on the covering device and has a bearing pin receptacle.

5. Covering device according to claim 1, wherein the longitudinal profiles are designed and/or arranged to be substantially mirror-symmetrical to one another.

6. Covering device according to claim 1, wherein the longitudinal profiles are each produced in the form of a cut and bent sheet metal component which is cut from sheet metal and has a plurality of wall portions which are bent off with respect to one another.

7. Covering device according to claim 1, wherein the longitudinal profiles are each nonreleasably connected to an inner wall portion of the covering cassette in a force- and/or form-fitting manner by means of fastening elements.

8. Covering device according to claim 7, wherein the fastening elements are each designed in the form of a welding dome which is produced from plastic and connected in an integrally bonded manner to the inner wall portion of the covering cassette.

9. Covering device according to claim 1, wherein an inner wall portion of the covering cassette that is arranged in the transverse direction between the longitudinal profiles is provided with a ribbing which has a plurality of ribs which are oriented transversely to one another, preferably at a right angle.
